(19) United States
(12) Patent Application Publication
(10) Pub. No.: US 2002/0113392 A1
(43) Pub. Date: Aug. 22, 2002

(54) Skid scooter

(76) Inventor: Chen-Hsiung Lin, Taichung (TW)

Correspondence Address: Chen-Hsiung Lin, 58, MA YUAN WEST ST., TAICHUNG, TW

(21) Appl. No.: 09/792,677

(22) Filed: Feb. 22, 2001

(51) Int. Cl. B62M 1/00; B60L 1/00

(52) U.S. Cl. 280/87.041; 188/19

(57) ABSTRACT

A skid scooter has a board, a holding seat disposed on a front portion of the board, a down tube inserted in the holding seat, a front tube connected to the down tube, a handle connected to the front tube, a front wheel disposed on a bottom of the front tube, a rear wheel disposed on a rear end of the board, a rear wheel cover disposed on a bottom of the board, and a rear wheel brake device disposed between the board and the rear wheel cover.

### BACKGROUND OF THE INVENTION

The present invention relates to a skid scooter. More particularly, the present invention relates to a skid scooter which has a rear wheel brake device.

Referring to FIG. 6, a conventional rear wheel brake device of a skid scooter has a main frame 21, a rear wheel 23, a rear wheel cover 31, a rear wheel support frame 25 connected to the main frame 21 and the rear wheel 23, and an elastic plate 32 having a proximal end 321 and a distal end 322. The main frame 21 has a through hole 211. A bolt 33 fastens the proximal end 321 of the elastic plate 32 and the main frame 21 together through the through hole 211 of the main frame 21. The rear wheel cover 31 has a curved portion 311 to contact the rear wheel 23 in order to break the rear wheel 23.

### SUMMARY OF THE INVENTION

An object of the present invention is to provide a skid scooter which has a rear wheel brake device to brake a rear wheel efficiently.

Accordingly, a skid scooter comprises a board, a holding seat disposed on a front portion of the board, a down tube inserted in the holding seat, a front tube connected to the down tube, a handle connected to the front tube, a front wheel disposed on a bottom of the front tube, a rear wheel disposed on a rear end of the board, a rear wheel cover disposed on a bottom of the board, and a rear wheel brake device disposed between the board and the rear wheel cover. The rear wheel brake device has a positioning plate, a post disposed on the positioning plate, and a spring enclosing the post. A pin fastens an end portion of the rear wheel cover and the positioning plate together.

### BRIEF DESCRIPTION OF THE DRAWINGS

FIG. 1 is an elevational assembly view of a skid scooter of a preferred embodiment in accordance with the present invention;

FIG. 2 is a perspective view of a rear wheel brake device of a preferred embodiment in accordance with the present invention;

FIG. 3 is a sectional view of a rear wheel brake device of a preferred embodiment in accordance with the present invention;

FIG. 4 is another sectional view of a rear wheel brake device of a preferred embodiment in accordance with the present invention;

FIG. 5 is a schematic view illustrating an operation of a rear wheel brake device of a preferred embodiment in accordance with the present invention; and

FIG. 6 is an elevational view of a conventional rear wheel brake device of the prior art.

### DETAILED DESCRIPTION OF THE INVENTION

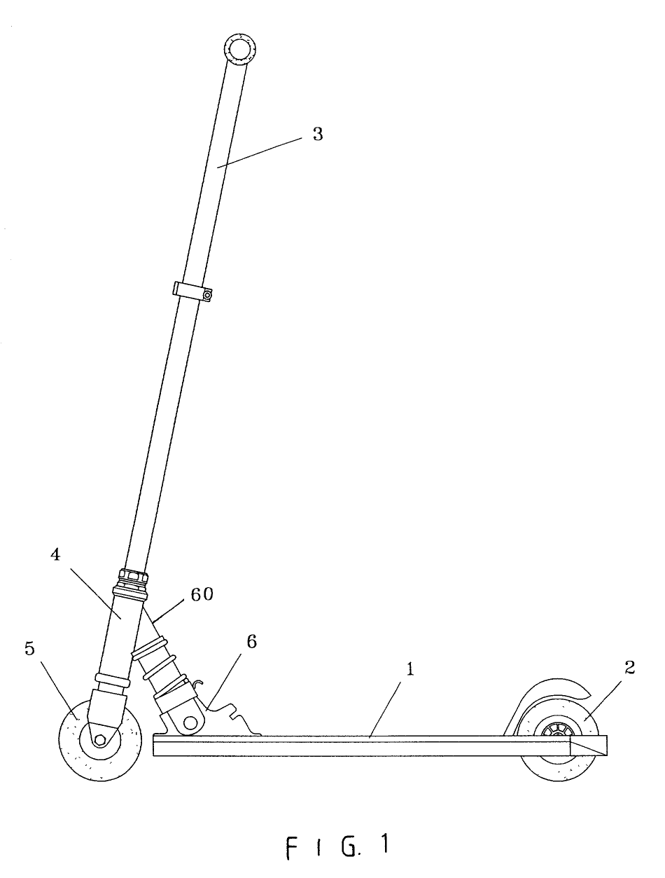

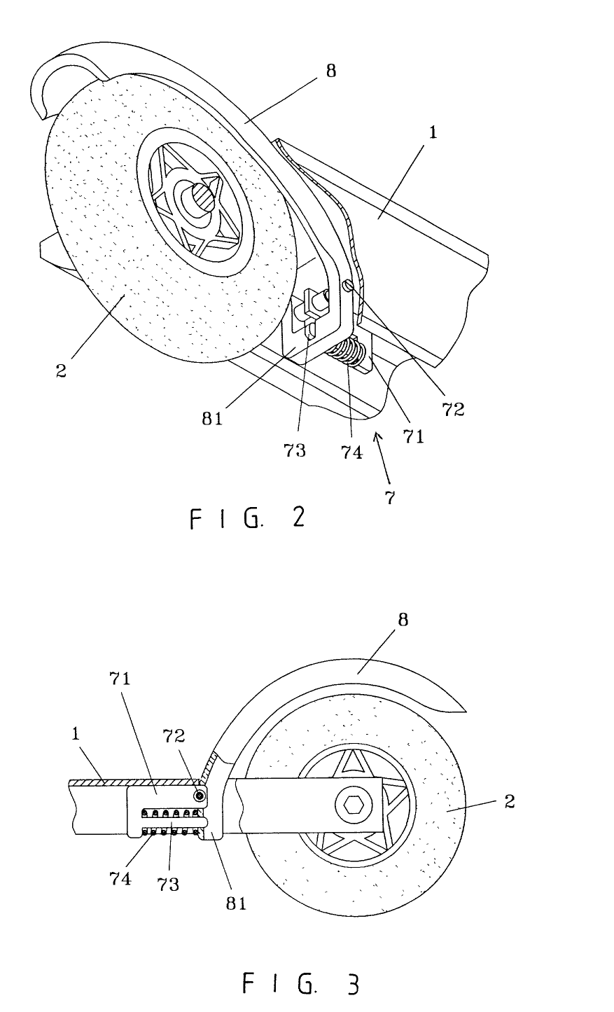

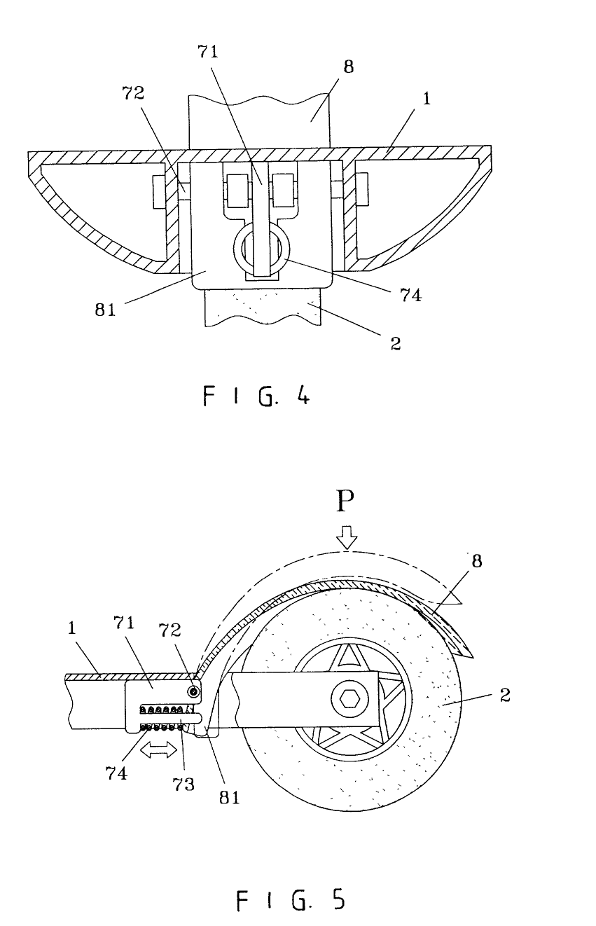

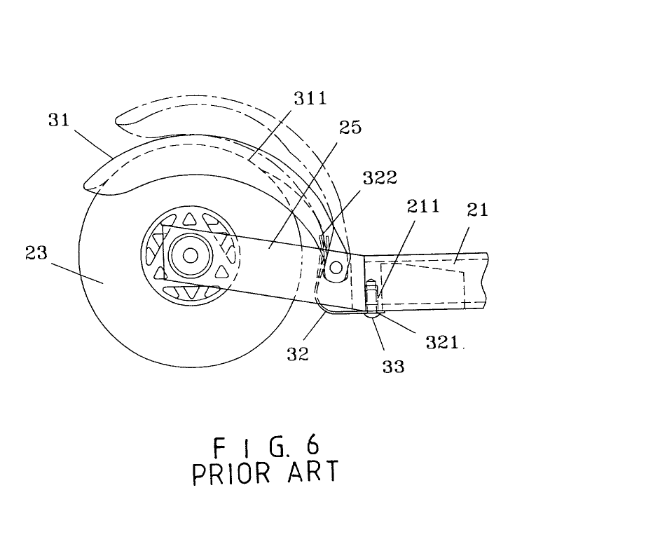

Referring to FIGS. 1 to 5, a skid scooter comprises a board 1, a holding seat 6 disposed on a front portion of the board 1, a down tube 60 inserted in the holding seat 6, a front tube 4 connected to the down tube 60, a handle 3 connected to the front tube 4, a front wheel 5 disposed on a bottom of the front tube 4, a rear wheel 2 disposed on a rear end of the board 1, a rear wheel cover 8 disposed on a bottom of the board 1, and a rear wheel brake device 7 disposed between the board 1 and the rear wheel cover 8.

The rear wheel brake device 7 has a positioning plate 71, a post 73 disposed on the positioning plate 71, and a spring 74 enclosing the post 73.

A pin 72 fastens an end portion 81 of the rear wheel cover 8 and the positioning plate 71 together.

The spring 74 contacts the end portion 81 of the rear wheel cover 8.

When the rear wheel cover 8 is pressed downward, the rear wheel cover 8 contacts the rear wheel 2 in order to brake the rear wheel 2.

When the rear wheel cover 8 is not pressed downward, the spring 74 is released and the rear wheel cover 8 will not contact the rear wheel 2.

The present invention is not limited to the above embodiment but various modification thereof may be made. Furthermore, various changes in form and detail may be made without departing from the scope of the present invention.

I claim:

1. A skid scooter comprises:
a board, a holding seat disposed on a front portion of the board, a down tube inserted in the holding seat, a front tube connected to the down tube, a handle connected to the front tube, a front wheel disposed on a bottom of the front tube, a rear wheel disposed on a rear end of the board, a rear wheel cover disposed on a bottom of the board, and a rear wheel brake device disposed between the board and the rear wheel cover,
the rear wheel brake device having a positioning plate, a post disposed on the positioning plate, and a spring enclosing the post, and
a pin fastening an end portion of the rear wheel cover and the positioning plate together.
